(19) United States
(12) Patent Application Publication
(10) Pub. No.: US 2026/0281308 A1
(43) Pub. Date: Sep. 17, 2026

(54) METHOD AND APPARATUS FOR ENCODING/DECODING IMAGE AND RECORDING MEDIUM FOR STORING BITSTREAM

(71) Applicants: HYUNDAI MOTOR COMPANY, Seoul (KR); KIA CORPORATION, Seoul (KR)

(72) Inventors: Jin Heo, Hwaseong-si (KR); Jungah Choi, Hwaseong-si (KR); Seung Wook Park, Hwaseong-si (KR)

(73) Assignees: HYUNDAI MOTOR COMPANY, Seoul (KR); KIA CORPORATION, Seoul (KR)

(21) Appl. No.: 19/471,614

(22) PCT Filed: Jun. 13, 2024
(86) PCT No.: PCT/KR2024/008138

§ 371 Date: Oct. 1, 2025

(30) Foreign Application Priority Data
Jun. 19, 2023 (KR) 10-2023-0078412
Jun. 13, 2024 (KR) 10-2024-0076931

(51) Int. Cl. H04N 19/105; H04N 19/119; H04N 19/132; H04N 19/139; H04N 19/176

(52) U.S. Cl. CPC H04N 19/105; H04N 19/119; H04N 19/132; H04N 19/139; H04N 19/176

(57) ABSTRACT

A method and apparatus for encoding/decoding an image, a recording medium for storing a bitstream, and a transmission method are provided. A method for decoding an image includes partitioning a current block into a first partitioned area and a second partitioned area along a partitioning boundary, deriving a prediction sample of the first partitioned area based on an advanced motion vector prediction (AMVP) mode, deriving a prediction sample of the second partitioned area based on a merge mode, and deriving a prediction sample of the current block by performing weighted summation of the prediction sample of the first partitioned area and the prediction sample of the second partitioned area.

### TECHNICAL FIELD

The prevent invention relates to a method and apparatus for encoding/decoding an image and a recording medium for storing a bitstream. Particularly, the prevent invention relates to a method and apparatus for encoding/decoding an image by using a AMVP-merge geometric partitioning mode, and a recording medium for storing a bitstream.

### BACKGROUND ART

Recently, the demand for high resolution and high quality images such as ultra high definition (UHD) images increases in various application image data becomes higher in resolution and quality, the amount of data increases relatively compared to existing image data. Therefore, when transmitting such image data using existing media such as wired or wireless broadband channels, or when storing it using existing storage media, both transmission and storage costs increase. To solve these problems that occur as image data becomes higher in resolution and quality, a high-efficiency image encoding/decoding technique is required for images with higher resolution and image quality.

Geometric partitioning mode (GPM) prediction is a technology that partitions a current block into two areas by a straight partitioning boundary, generates respective prediction signals of the two partitioned areas by performing intra prediction or inter prediction independently on the two areas, and generates a prediction block for the current block by performing weighted summation of the prediction signals.

### DISCLOSURE

### Technical Problem

An object of the present invention is to provide a method and apparatus encoding/decoding improved encoding/decoding efficiency.

Another object of the present invention is to provide a recording medium for storing a bitstream that is generated by generated by a method or apparatus for decoding an image according to the present invention.

Another object of the present invention is to provide an AMVP-merge geometric partitioning mode.

### Technical Solution

A method for decoding an image according to an embodiment of the present invention includes partitioning a current block into a first partitioned area and a second partitioned area along a partitioning boundary, deriving a prediction sample of the first partitioned area based on an advanced motion vector prediction (AMVP) mode, deriving a prediction sample of the second partitioned area based on a merge mode, and deriving a prediction sample of the current block by performing weighted summation of the prediction sample of the first partitioned area and the prediction sample of the second partitioned area.

In the method for decoding the image, the prediction sample of the first partitioned area may be derived based on AMVP motion information that is obtained from a bitstream.

In the method for decoding the image, the AMVP motion information may include motion vector difference information and reference picture information.

In the method for decoding the image, the prediction sample of the second partitioned area may be derived based on motion information of a merge candidate that is selected from a plurality of merge candidates.

In the method for decoding the image, the selected merge candidate may be determined based on distortion of the prediction sample of the first partitioned area and candidate prediction samples of the second partitioned area based on motion information of each of the plurality of merge candidates.

In the method for decoding the image, the distortion may be calculated based on bilateral matching.

In the method for decoding the image, the distortion may be calculated based on template matching.

In the method for decoding the image, the template matching may use an L-shaped template.

In the method for decoding the image, the template matching may use any one template of an upper template and a left template.

In the method for decoding the image, the template matching may use a template that is determined according to the partitioning boundary.

In the method for decoding the image, a reference picture of the AMVP mode and a reference picture of the merge mode may be in different directions from each other.

A method for encoding an image according to an embodiment of the present invention includes partitioning a current block into a first partitioned area and a second partitioned area along a partitioning boundary, deriving a prediction sample of the first partitioned area based on an advanced motion vector prediction (AMVP) mode, deriving a prediction sample of the second partitioned area based on a merge mode, and deriving a prediction sample of the current block by performing weighted summation of the prediction sample of the first partitioned area and the prediction sample of the second partitioned area.

A non-transitory computer-readable recording medium according to an embodiment of the present invention may store a bitstream that is generated by a method for encoding an image, and the method for encoding the image includes partitioning a current block into a first partitioned area and a second partitioned area along a partitioning boundary, deriving a prediction sample of the first partitioned area based on an advanced prediction (AMVP) mode, deriving a prediction sample of the second partitioned area based on a merge mode, and deriving a prediction sample of the current block by performing weighted summation of the prediction sample of the first partitioned area and the prediction sample of the second partitioned area.

A method for transmitting a bitstream generated by a method for encoding an image according to an embodiment of the present invention includes transmitting the bitstream. The method for encoding the image includes partitioning a current block into a first partitioned area and a second partitioned area along a partitioning boundary, deriving a prediction sample of the first partitioned area based on an advanced motion vector prediction (AMVP) mode, deriving a prediction sample of the second partitioned area based on a merge mode, and deriving a prediction sample of the current block by performing weighted summation of the prediction sample of the first partitioned area and the prediction sample of the second partitioned area.

The features briefly summarized above with respect to the present disclosure are provided as an example only to explain the detailed description and are not construed to limit the scope of the present disclosure.

### Advantageous Effects

According to the present invention, a method and apparatus for encoding/decoding an image with improved encoding/decoding efficiency may be provided.

In addition, according to the present invention, an AMVP-merge geometric partitioning mode may be provided.

In addition, according to the present invention, merge index or AMVP motion vector prediction information may be derived in a decoder without being transmitted/parsed through a bitstream, thereby improving coding efficiency.

In addition, according to the present invention, prediction accuracy may be improved.

Effects obtainable from the present disclosure are not limited to the above-mentioned effects, and other effects that are not mentioned will be clearly understood by those skilled in the art from the following description.

### DESCRIPTION OF DRAWINGS

FIG. 1 is a block diagram showing a configuration of an encoding apparatus according to an embodiment of the present invention.

FIG. 2 is a block diagram showing a configuration of a decoding apparatus according to an embodiment of the present invention.

FIG. 3 is a diagram schematically showing a video coding system to which the present invention is applicable.

FIG. 4 shows combinations of intra prediction and inter prediction that may occur in a geometric partitioning mode.

FIG. 5 is a view for describing a method for generating a prediction signal of a geometric partitioning mode through inter-inter prediction.

FIG. 6 is a view for describing an AMVP-merge geometric partitioning mode according to an embodiment of the present invention.

FIG. 7 is a view describing a method for calculating distortion based on template matching to derive a merge index in an AMVP-merge geometric partitioning mode according to an embodiment of the present invention.

FIG. 8 is a view partition angles according to an embodiment of the present invention.

FIG. 9 is a view illustrating a template shape of a first partitioned area and a template shape of a second partitioned area when a partition angle is 0.

FIG. 10 is a view illustrating a template shape of a first partitioned area and a template shape of a second partitioned area when a partition angle is 8.

FIG. 11 is a view illustrating a template shape of a first partitioned area and a template shape of a second partitioned area when a partition angle is 20.

FIG. 12 is a view illustrating a template shape of a first partitioned area and a template shape of a second partitioned area when a partition angle is 28.

FIG. 13 is a flowchart showing a method for decoding an image according to an embodiment of the present invention.

FIG. 14 is a view for illustrating a content streaming system to which an embodiment according to the present invention is applicable.

### MODE FOR INVENTION

The present invention may have various modifications and embodiments, and specific embodiments are illustrated in the drawings and described in detail in the detailed description. However, this is not intended to limit the present invention to specific embodiments, but should be understood to include all modifications, equivalents, or substitutes included in the spirit and technical scope of the present invention. Similar reference numerals in the drawings indicate the same or similar functions throughout various aspects. The shapes and sizes of elements in the drawings may be provided by way of example for a clearer description. The detailed description of the exemplary embodiments described below refers to the accompanying drawings, which illustrate specific embodiments by way of example. These embodiments are described in sufficient detail to enable those skilled in the art to practice the embodiments. It should be understood that the various embodiments are different from each other, but are not necessarily mutually exclusive. For example, specific shapes, structures, and characteristics described herein may be implemented in other embodiments without departing from the spirit and scope of the present invention with respect to one embodiment. It should also be understood that the positions or arrangements of individual components within each disclosed embodiment may be changed without departing from the spirit and scope of the embodiment. Accordingly, the detailed description set forth below is not intended to be limiting, and the scope of the exemplary embodiments is defined only by the appended claims, along with the full scope of equivalents to which such claims are entitled, if properly described.

In the present invention, the terms first, second, etc. may be used to describe various components, but the components should not be limited by the terms. The terms are only used for the purpose of distinguishing one component from another. For example, without departing from the scope of the present invention, the first component may be referred to as the second component, and similarly, the second component may also be referred to as the first component. The term is and/or includes a combination of a plurality of related described items or any item among a plurality of related described items.

The components shown in the embodiments of the present invention are independently depicted to indicate different characteristic functions, and do not mean that each component is formed as a separate hardware or software configuration unit. That is, each component is listed and included as a separate component for convenience of explanation, and at least two of the components may be combined to form a single component, or one component may be divided into multiple components to perform a function, and embodiments in which components are integrated and embodiments in which each component is divided are also included in the scope of the present invention as long as they do not deviate from the essence of the present invention.

The terminology used in the present invention is only used to describe specific embodiments and is not intended to limit the present invention. The singular expression includes the plural expression unless the context clearly indicates otherwise. In addition, some components of the present invention are not essential components that perform essential functions in the present invention and may be optional components only for improving performance. The present invention may be implemented by including only essential components for implementing the essence of the present invention excluding components only used for improving performance, and a structure including only essential components excluding optional components only used for improving performance is also included in the scope of the present invention.

In an embodiment, the term “at least one” may mean one of a number greater than or equal to 1, such as 1, 2, 3, and 4. In an embodiment, the term “a plurality of” may mean one of a number greater than or equal to 2, such as 2, 3, and 4.

Hereinafter, embodiments of the present invention will be specifically described with reference to the drawings. In describing the embodiments of this specification, if it determined that a detailed description of a related known configuration or function may obscure the subject matter of this specification, the detailed description will be omitted, and the same reference numerals will be used for the same components in the drawings, and repeated descriptions of the same components will be omitted.

### DESCRIPTION OF TERMS

Hereinafter, “image” may mean one picture constituting a video, and may also refer to the video itself. For example, “encoding and/or decoding of an image” may mean “encoding and/or decoding of a video,” and may also mean “encoding and/or decoding of one of images constituting the video.”

Hereinafter, “moving image” and “video” may be used with the same meaning and may be used interchangeably. In addition, a target image may be an encoding target image that is a target of encoding and/or a decoding target image that is a target of decoding. In addition, the target image may be an input image input to an encoding apparatus and may be an input image input to a decoding apparatus. Here, the target image may have the same meaning as a current image.

Hereinafter, encoder and image encoding apparatus may be used with the same meaning and may be used interchangeably.

Hereinafter, decoder and image decoding apparatus may be used with the same meaning and may be used interchangeably.

Hereinafter, “image”, “picture”, “frame” and “screen” may be used with the same meaning and may be used interchangeably.

Hereinafter, a “target block” may be an encoding target block that is a target of encoding and/or a decoding target block that is a target of decoding. In addition, the target block may be a current block that is a target of current encoding and/or decoding. For example, “target block” and “current block” may be used with the same meaning and may be used interchangeably.

Hereinafter, “block” and “unit” may be used with the same meaning and may be used interchangeably. In addition, “unit” may mean including a luma component block and a chroma component block corresponding thereto in order to distinguish it from a block. For example, a coding tree unit (CTU) may be composed of one luma component (Y) coding tree block (CTB) and two chroma component (Cb, Cr) coding tree blocks related to it.

Hereinafter, “sample”, “picture element” and “pixel” may be used with the same meaning and may be used interchangeably. Herein, a sample may represent a basic unit that constitutes a block.

Hereinafter, “inter” and “inter-screen” may be used with the same meaning and can be used interchangeably.

Hereinafter, “intra” and “in-screen” may be used with the same meaning and can be used interchangeably.

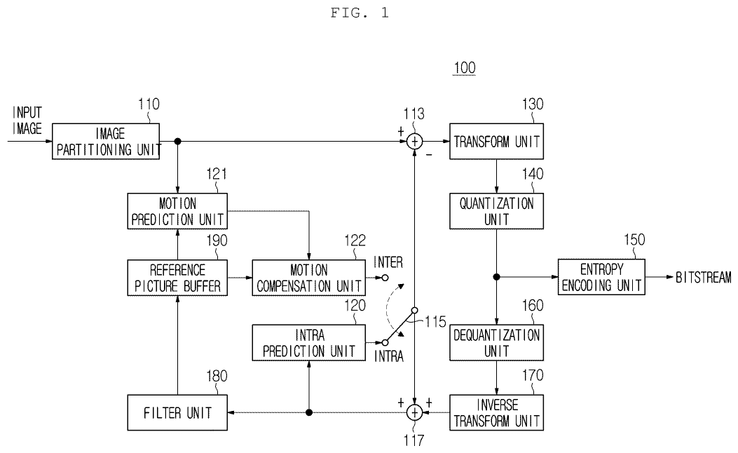

FIG. 1 is a block diagram showing a configuration of an encoding apparatus according to an embodiment of the present invention.

The encoding apparatus 100 may be an encoder, a video encoding apparatus, or an image encoding apparatus. A video may include one or more images. The encoding apparatus 100 may sequentially encode one or more images.

Referring to FIG. 1, the encoding apparatus 100 may include an image partitioning unit 110, an intra prediction unit 120, a motion prediction unit 121, a motion compensation unit 122, a switch 115, a subtractor 113, a transform unit 130, a quantization unit 140, an entropy encoding unit 150, a dequantization unit 160, an inverse transform unit 170, an adder 117, a filter unit 180 and a reference picture buffer 190.

In addition, the encoding apparatus 100 may generate a bitstream including information encoded through encoding of an input image, and output the generated bitstream. The generated bitstream may be stored in a computer-readable recording medium, or may be streamed through a wired/wireless transmission medium.

The image partitioning unit 110 may partition the input image into various forms to increase the efficiency of video encoding/decoding. That is, the input video is composed of multiple pictures, and one picture may be hierarchically partitioned and processed for compression efficiency, parallel processing, etc. For example, one picture may be partitioned into one or multiple tiles or slices, and then partitioned again into multiple CTUs (Coding Tree Units). Alternatively, one picture may first be partitioned into multiple sub-pictures defined as groups of rectangular slices, and each sub-picture may be partitioned into the tiles/slices. Here, the sub-picture may be utilized to support the function of partially independently encoding/decoding and transmitting picture. Since multiple sub-pictures may be individually reconstructed, it has the advantage of easy editing in applications that configure multi-channel inputs into one picture. In addition, a tile may be divided horizontally to generate bricks. Here, the brick may be utilized as the basic unit of parallel processing within the picture. In addition, one CTU may be recursively partitioned into quad trees (QTs), and the terminal node of the partition may be defined as a CU (Coding Unit). The CU may be partitioned into a PU (Prediction Unit), which is a prediction unit, and a TU (Transform Unit), which is a transform unit, to perform prediction and partition. Meanwhile, the CU may be utilized as the prediction unit and/or the transform unit itself. Here, for flexible partition, each CTU may be recursively partitioned into multi-type trees (MTTs) as well as quad trees (QTs). The partition of the CTU into multi-type trees may start from the terminal node of the QT, and the MTT may be composed of a binary tree (BT) and a triple tree (TT). For example, the MTT structure may be classified into a vertical binary split mode (SPLIT_BT_VER), a horizontal binary split mode (SPLIT_BT_HOR), a vertical ternary split mode (SPLIT_TT_VER), and a horizontal ternary split mode (SPLIT_TT_HOR). In addition, a minimum block size (MinQTSize) of the quad tree of the luma block during partition may be set to 16×16, a maximum block size (MaxBtSize) of the binary tree may be set to 128×128, and a maximum block size (MaxTtSize) of the triple tree may be set to 64×64. In addition, a minimum block size (MinBtSize) of the binary tree and a minimum block size (MinTtSize) of the triple tree may be specified as 4×4, and the maximum depth (MaxMttDepth) of the multi-type tree may be specified as 4. In addition, in order to increase the encoding efficiency of the I slice, a dual tree that differently uses CTU partition structures of luma and chroma components may be applied. On the other hand, in P and B slices, the luma and chroma CTBs (Coding Tree Blocks) within the CTU may be partitioned into a single tree that shares the coding tree structure.

The encoding apparatus 100 may perform encoding on the input image in the intra mode and/or the inter mode. Alternatively, the encoding apparatus 100 may perform encoding on the input image in a third mode (e.g., IBC mode, Palette mode, etc.) other than the intra mode and the inter mode. However, if the third mode has functional similar to the intra mode or the inter mode, it may be classified as the intra mode or the inter mode for convenience of explanation. In the present invention, the third mode will be classified and described separately only when a specific description thereof is required.

When the intra mode is used as the prediction mode, the switch 115 may be switched to intra, and when the inter mode is used as the prediction mode, the switch 115 may be switched to inter. Here, the intra mode may mean an intra prediction mode, and the inter mode may mean an inter prediction mode. The encoding apparatus 100 may generate a prediction block for an input block of the input image. In addition, the encoding apparatus 100 may encode a residual block using a residual of the input block and the prediction block after the prediction block is generated. The input image may be referred to as a current image which is a current encoding target. The input block may be referred to as a current block which is a current encoding target or an encoding target block.

When a prediction mode is an intra mode, the intra prediction unit 120 may use a sample of a block that has been already encoded/decoded around a current block as a reference sample. The intra prediction unit 120 may perform spatial prediction for the current block by using the reference sample, or generate prediction samples of an input block through spatial prediction. Herein, the intra prediction may mean in-screen prediction.

As an intra prediction method, non-directional prediction modes such as DC mode and Planar mode and directional prediction modes (e.g., 65 directions) may be applied. Here, the intra prediction method may be expressed as an intra prediction mode or an in-screen prediction mode.

When a prediction mode is an inter mode, the motion prediction unit 121 may retrieve a region that best matches with an input block from a reference image in a motion prediction process, and derive a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 122 may generate a prediction block of the current block by performing motion compensation using a motion vector. Herein, inter prediction may mean inter-screen prediction or motion compensation.

When the value of the motion vector is not an integer, the motion prediction unit 121 and the motion compensation unit 122 may generate the prediction block by applying an interpolation filter to a partial region of the reference picture. In order to perform inter prediction or motion compensation, it may be determined whether the motion prediction and motion compensation mode of the prediction unit included in the coding unit is one of a skip mode, a merge mode, an advanced motion vector prediction (AMVP) mode, and an intra block copy (IBC) mode based on the coding unit and inter prediction or motion compensation may be performed according to each mode.

In addition, based on the above inter prediction method, an AFFINE mode of sub-PU based prediction, an SbTMVP (Subblock-based Temporal Motion Vector Prediction) mode, an MMVD (Merge with MVD) mode of PU-based prediction, and a GPM (Geometric Partitioning Mode) mode may be applied. In addition, in order to improve the performance of each mode, HMVP (History based MVP), PAMVP (Pairwise Average MVP), CIIP (Combined Intra/Inter Prediction), AMVR (Adaptive Motion Vector Resolution), BDOF (Bi-Directional Optical-Flow), BCW (Bi-predictive with CU Weights), LIC (Local Illumination Compensation), TM (Template Matching), OBMC (Overlapped Block Motion Compensation), etc. may be applied.

Among these, the AFFINE mode is a technology that is used in both AMVP and MERGE modes and also has high encoding efficiency. In the existing video coding standard, since MC (Motion Compensation) is performed by considering only the parallel movement of blocks, it has a disadvantage in that it cannot properly compensate for motions that occur in reality, such as zoom-in/out and rotation. To supplement this, a four-parameter affine motion model using two control point motion vectors (CPMVs) and a six-parameter affine motion model using three control point motion vectors may be used and applied to inter prediction. Here, CPMV is a vector representing the affine motion model of one of the upper left, upper right, and lower left of the current block.

The subtractor 113 may generate a residual block by using a difference between an input block and a prediction block. The residual block may be called a residual signal. The residual signal may mean a difference between an original signal and a prediction signal. Alternatively, the residual signal may be a signal generated by transforming or quantizing, or transforming and quantizing a difference between the original signal and the prediction signal. The residual block may be a residual signal of a block unit.

The transform unit 130 may generate a transform coefficient by performing transform on a residual block, and output the generated transform coefficient. Herein, the transform coefficient may be a coefficient value generated by performing transform on the residual block. When a transform skip mode is applied, the transform unit 130 may skip transform of the residual block.

A quantized level may be generated by applying quantization to the transform coefficient or to the residual signal. Hereinafter, the quantized level may also be called a transform coefficient in embodiments.

For example, a 4×4 luma residual block generated through intra prediction is transformed using a base vector based on DST (Discrete Sine Transform), and transform may be performed on the remaining residual block using a base vector based on DCT (Discrete Cosine Transform). In addition, a transform block is partitioned into a shape for one block using RQT (Residual Quad Tree) technology, and after performing transform and quantization on each transformed block partitioned through ROT, a coded block flag (cbf) may be transmitted to increase encoding efficiency when all coefficients become 0.

As another alternative, the Multiple Transform Selection (MTS) technique, which selectively uses multiple transform bases to perform transform, may be applied. That is, instead of partitioning a CU into TUs through ROT, a function similar to TU partition may be performed through the sub-block Transform (SBT) technique. Specifically, SBT is applied only to inter prediction blocks, and unlike ROT, the current block may be partitioned into ½ or ¼ sizes in the vertical or horizontal direction and then transform may be performed on only one of the blocks. For example, if it is partitioned vertically, transform may be performed on the leftmost or rightmost block, and if it is partitioned horizontally, transform may be performed on the topmost or bottommost block.

In addition, LFNST (LOW Frequency Non-Separable Transform), a secondary transform technique that additionally transforms the residual signal transformed into the frequency domain through DCT or DST, may be applied. LFNST additionally performs transform on the low-frequency region of 4×4 or 8×8 in the upper left, so that the residual coefficients may be concentrated in the upper left.

The quantization unit 140 may generate a quantized level by quantizing the transform coefficient of the residual signal according to a quantization parameter (QP), and output the generated quantized level. Herein, the quantization unit 140 may quantize the transform coefficient by using a quantization matrix.

For example, a quantizer using QP values of 0 to 51 may be used. Alternatively, if the image size is larger and high encoding efficiency is required, the QP of 0 to 63 may be used. Also, a DQ (Dependent Quantization) method using two quantizers instead of one quantizer may be applied. DQ performs quantization using two quantizers (e.g., Q0 and Q1), but even without signaling information about the use of a specific quantizer, the quantizer to be used for the next transform coefficient may be selected based on the current state through a state transition model.

The entropy encoding unit 150 may generate a bitstream by performing entropy encoding according to a probability distribution on values calculated by the quantization unit 140 or on coding parameter values calculated when performing encoding, and output the bitstream. The entropy encoding unit 150 may perform entropy encoding of information on a sample of an image and information for decoding an image. For example, the information for decoding the image may include a syntax element.

When entropy encoding is applied, symbols are represented so that a smaller number of bits are assigned to a symbol having a high occurrence probability and a larger number of bits are assigned to a symbol having a low occurrence probability, and thus, the size of bit stream for symbols to be encoded may be decreased. The entropy encoding unit 150 may use an encoding method, such as exponential Golomb, context-adaptive variable length coding (CAVLC), context-adaptive binary arithmetic coding (CABAC), etc., for entropy encoding. For example, the entropy encoding unit 150 may perform entropy encoding by using a variable length coding/code (VLC) table. In addition, the entropy encoding unit 150 may derive a binarization method of a target symbol and a probability model of a target symbol/bin, and perform arithmetic coding by using the derived binarization method, and a context model.

In relation to this, when applying CABAC, in order to reduce the size of the probability table stored in the decoding apparatus, a table probability update method may be changed to a table update method using a simple equation and applied. In addition, two different probability models may be used to obtain more accurate symbol probability values.

In order to encode a transform coefficient level (quantized level), the entropy encoding unit 150 may change a two-dimensional block form coefficient into a one-dimensional vector form through a transform coefficient scanning method.

A coding parameter may include information (flag, index, etc.) encoded in the encoding apparatus 100 and signaled to the decoding apparatus 200, such as syntax element, and information derived in the encoding or decoding process, and may mean information required when encoding or decoding an image.

Herein, signaling the flag or index may mean that a corresponding flag or index is entropy encoded and included in a bitstream in an encoder, and may mean that the corresponding flag or index is entropy decoded from a bitstream in a decoder.

The encoded current image may be used as a reference image for another image to be processed later. Therefore, the encoding apparatus 100 may reconstruct or decode the encoded current image again and store the reconstructed or decoded image as a reference image in the reference picture buffer 190.

A quantized level may be dequantized in the dequantization unit 160, or may be inversely transformed in the inverse transform unit 170. A dequantized and/or inversely transformed coefficient may be added with a prediction block through the adder 117. Herein, the dequantized and/or inversely transformed coefficient may mean a coefficient on which at least one of dequantization and inverse transform is performed, and may mean a reconstructed residual block. The dequantization unit 160 and the inverse transform unit 170 may be performed as an inverse process of the quantization unit 140 and the transform unit 130.

The reconstructed block may pass through the filter unit 180. The filter unit 180 may apply all or some filtering techniques among a deblocking filter, a sample adaptive offset (SAO), an adaptive loop filter (ALF), a bilateral filter (BIF), luma mapping with chroma scaling (LMCS), etc. to a reconstructed sample, a reconstructed block or a reconstructed image. The filter unit 180 may be called an in-loop filter. In this case, the in-loop filter is also used as name excluding LMCS.

The deblocking filter may remove block distortion generated in boundaries between blocks. In order to determine whether or not to apply a deblocking filter, whether or not to apply a deblocking filter to a current block may be determined based on samples included in several rows or columns which are included in the block. When a deblocking filter is applied to a block, a different filter may be applied according to a required deblocking filtering strength.

In order to compensate for encoding error using sample adaptive offset, a proper offset value may be added to a sample value. The sample adaptive offset may correct an offset of a deblocked image from an original image by a sample unit. A method of partitioning a sample included in an image into a predetermined number of regions, determining a region to which an offset is applied, and applying the offset to the determined region, or a method of applying an offset in consideration of edge information on each sample may be used.

A bilateral filter (BIF) may also correct the offset from the original image on a sample-by-sample basis for the image on which deblocking has been performed.

The adaptive loop filter may perform filtering based on a comparison result of the reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the adaptive loop filter to be applied to each block may vary.

In LMCS (Luma Mapping with Chroma Scaling), luma mapping (LM) means remapping luma values through a piece-wise linear model, and chroma scaling (CS) means a technique for scaling the residual value of the chroma component according to the average luma value of the prediction signal. In particular, LMCS may be utilized as an HDR correction technique that reflects the characteristics of HDR (High Dynamic Range) images.

The reconstructed block or the reconstructed image having passed through the filter unit 180 may be stored in the reference picture buffer 190. A reconstructed block that has passed through the filter unit 180 may be a part of a reference image. That is, the reference image is a reconstructed image composed of reconstructed blocks that have passed through the filter unit 180. The stored reference image may be used later in inter prediction or motion compensation.

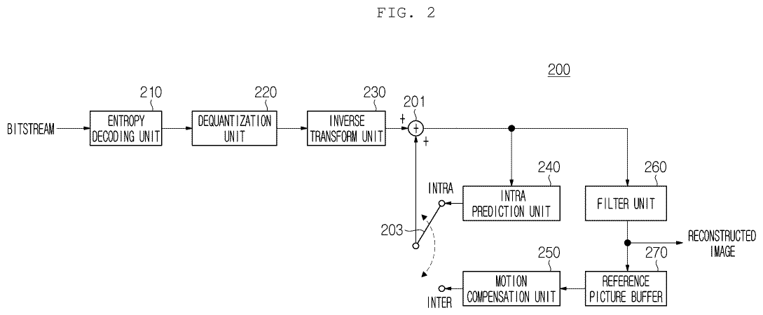

FIG. 2 is a block diagram showing a configuration of a decoding apparatus according to an embodiment of the present invention.

A decoding apparatus 200 may a decoder, a video decoding apparatus, or an image decoding apparatus.

Referring to FIG. 2, the decoding apparatus 200 may include an entropy decoding unit 210, a dequantization unit 220, an inverse transform unit 230, an intra prediction unit 240, a motion compensation unit 250, an adder 201, a switch 203, a filter unit 260, and a reference picture buffer 270.

The decoding apparatus 200 may receive a bitstream output from the encoding apparatus 100. The decoding apparatus 200 may receive a bitstream stored in a computer-readable recording medium, or may receive a bitstream that is streamed through a wired/wireless transmission medium. The decoding apparatus 200 may decode the bitstream in an intra mode or an inter mode. In addition, the decoding apparatus 200 may generate a reconstructed image generated through decoding or a decoded image, and output the reconstructed image or decoded image.

When a prediction mode used for decoding is an intra mode, the switch 203 may be switched to intra. Alternatively, when a prediction mode used for decoding is an inter mode, the switch 203 may be switched to inter.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block and the prediction block. The decoding target block may be called a current block.

The entropy decoding unit 210 may generate symbols by entropy decoding the bitstream according probability distribution. The generated symbols may include a symbol of a quantized level form. Herein, an entropy decoding method may be an inverse process of the entropy encoding method described above.

The entropy decoding unit 210 may change a one-dimensional vector-shaped coefficient into a two-dimensional block-shaped coefficient through a transform coefficient scanning method to decode a transform coefficient level (quantized level).

A quantized level may be dequantized in the dequantization unit 220, or inversely transformed in the inverse transform unit 230. The quantized level may be a result of dequantization and/or inverse transform, and may be generated as a reconstructed residual block. Herein, the dequantization unit 220 may apply a quantization matrix to the quantized level. The dequantization unit 220 and the inverse transform unit 230 applied to the decoding apparatus may apply the same technology as the dequantization unit 160 and inverse transform unit 170 applied to the aforementioned encoding apparatus.

When an intra mode is used, the intra prediction unit 240 may generate a prediction block by performing, on the current block, spatial prediction that uses a sample value of a block which has been already decoded around a decoding target block. The intra prediction unit 240 applied to the decoding apparatus may apply the same technology as the intra prediction unit 120 applied to the aforementioned encoding apparatus.

When an inter mode is used, the motion compensation unit 250 may generate a prediction block by performing, on the current block, motion compensation that uses a motion vector and a reference image stored in the reference picture buffer 270. The motion compensation unit 250 may generate a prediction block by applying an interpolation filter to a partial region within a reference image when the value of the motion vector is not an integer value. In order to perform motion compensation, it may be determined whether the motion compensation method of the prediction unit included in the corresponding coding unit is a skip mode, a merge mode, an AMVP mode, or a current picture reference mode based on the coding unit, and motion compensation may be performed according to each mode. The motion compensation unit 250 applied to the decoding apparatus may apply the same technology as the motion compensation unit 122 applied to the encoding apparatus described above.

The adder 201 may generate a reconstructed block by adding the reconstructed residual block and the prediction block. The filter unit 260 may apply at least one of inverse-LMCS, a deblocking filter, a sample adaptive offset, and an adaptive loop filter to the reconstructed block or reconstructed image. The filter unit 260 applied to the decoding apparatus may apply the same filtering technology as that applied to the filter unit 180 applied to the aforementioned encoding apparatus.

The filter unit 260 may output the reconstructed image. The reconstructed block or reconstructed image may be stored in the reference picture buffer 270 and used for inter prediction. A reconstructed block that has passed through the filter unit 260 may be a part of a reference image. That is, a reference image may be a reconstructed image composed of reconstructed blocks that have passed through the filter unit 260. The stored reference image may be used later in inter prediction or motion compensation.

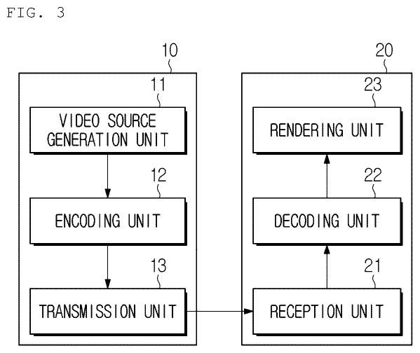

FIG. 3 is a diagram schematically showing a video coding system to which the present invention is applicable.

A video coding system according to an embodiment may include an encoding apparatus 10 and a decoding apparatus 20. The encoding apparatus 10 may transmit encoded video and/or image information or data to the decoding apparatus 20 in the form of a file or streaming through a digital storage medium or a network.

The encoding apparatus 10 according to an embodiment may include a video source generation unit 11, an encoding unit 12, and a transmission unit 13. The decoding apparatus 20 according to an embodiment may include a reception unit 21, a decoding unit 22, and a rendering unit 23. The encoding unit 12 may be called a video/image encoding unit, and the decoding unit 22 may be called a video/image decoding unit. The transmission unit 13 may be included in the encoding unit 12. The reception unit 21 may be included in the decoding unit 22. The rendering unit 23 may include a display unit, and the display unit may be configured as a separate device or an external component.

The video source generation unit 11 may obtain the video/image through a process of capturing, synthesizing, or generating the video/image. The video source generation unit 11 may include a video/image capture device and/or a video/image generation device. The video/image capture device may include, for example, one or more cameras, a video/image archive including previously captured video/image, etc. The video/image generation device may include, for example, a computer, a tablet, and a smartphone, etc., and may (electronically) generate the video/image. For example, a virtual video/image may be generated through a computer, etc., in which case the video/image capture process may be replaced with a process of generating related data.

The encoding unit 12 may encode the input video/image. The encoding unit 12 may perform a series of procedures such as prediction, transform, and quantization for compression and encoding efficiency. The encoding unit may output encoded data (encoded video/image information) in the form of a bitstream. The detailed configuration of the encoding unit 12 may also be configured in the same manner as the encoding apparatus 100 of FIG. 1 described above.

The transmission unit 13 may transmit encoded video/image information or data output in the form of a bitstream to the reception unit 21 of the decoding apparatus 20 through a digital storage medium or a network in the form of a file or streaming. The digital storage medium may include various storage media such as USB, SD, CD, DVD, Blu-ray, HDD, SSD, etc. The transmission unit 13 may include an element for generating a media file through a predetermined file format and may include an element for transmission through a broadcasting/communication network. The reception unit may extract/receive the bitstream from the storage medium or the network and transmit it to the decoding unit 22.

The decoding unit 22 may decode the video/image by performing a series of procedures such as dequantization, inverse transform, and prediction corresponding to the operation of the encoding unit 12. The detailed configuration of the decoding unit 22 may also be configured in the same manner as the above-described decoding apparatus 200 of FIG. 2.

The rendering unit 23 may render the decoded video/image. The rendered video/image may be displayed through the display unit.

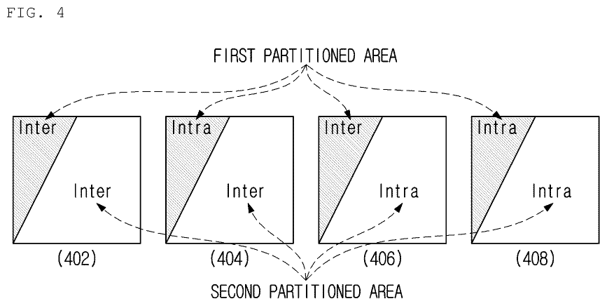

Hereinafter a geometric partitioning mode (GPM) using an advanced motion vector prediction (AMVP)-merge mode according to an embodiment of the present invention will be described with reference to FIGS. 4 to 12. Hereinafter the geometric partitioning mode using the AMVP-merge mode will be referred to as an AMVP-merge geometric partitioning mode.

The geometric partitioning mode (GPM) is a technique that partitions one coding unit (CU) into two partitions by a partitioning boundary, determines prediction signals corresponding to the two partitions independently of each other, and then generates a final prediction block by performing weighted summation of the generated prediction signals.

In the geometric partitioning mode, a current block is partitioned into two partitions by a straight partitioning boundary. In addition, a prediction block for each of the partitioned areas is generated according to inter-inter prediction, intra-intra prediction, or intra-inter prediction. In addition, a prediction block of the current block may be generated by performing weighted summation of prediction signals of the two prediction blocks.

FIG. 4 shows combinations of intra prediction and inter prediction that may occur in a geometric partitioning mode.

According to an embodiment, two partitions that are separated according to the geometric partitioning mode may each be independently predicted by intra prediction or inter prediction.

An inter-inter prediction combination is applied to a block 402 of FIG. 4. According to the prediction combination, two partitions may be independently predicted according to different information. Herein, unidirectional motion compensation is performed for each of the partitions.

An intra-inter prediction combination is applied to a block 404 and a block 406 of FIG. 4. According to the prediction combination, one of the two partitions is predicted according to intra prediction, and the other one is predicted according to inter prediction. Herein, for the partition using inter prediction, unidirectional motion compensation is performed, and the partition using intra prediction is predicted based on an intra prediction mode.

An inter-inter prediction combination is applied to a block 408 of FIG. 4. According to the prediction combination, two partitions are independently predicted based on different intra prediction modes.

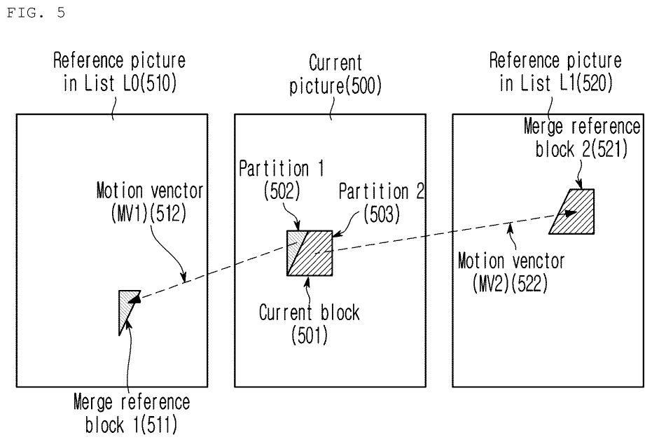

FIG. 5 is a view for describing an embodiment of a method for generating a prediction signal of a geometric partitioning mode through inter-inter prediction of the block 402 of FIG. 4. In particular, FIG. 5 shows an embodiment of a geometric partitioning mode that performs inter-inter prediction using a merge mode.

Referring to FIG. 5, a current block 501 may be partitioned into a first partitioned area (Partition 1) 502 and a second partitioned area (Partition 2) 503 by a partitioning boundary. In addition, first merge reference block 1 511 in a reference picture 510 of list L0 may be derived based on the first partitioned area 502 and a first motion vector MV1 512, and second merge reference block 2 521 in a reference picture 520 of list L1 may be derived based on the second partitioned area 503 and a second motion vector MV2 522. Herein, the first motion vector 512 and the second motion vector 522 may be derived from a merge candidate list for geometric partitioning mode (GMP merge candidate list) that includes only unidirectional motion information from a regular merge candidate list. In addition, a prediction block for a final geometric partitioning mode may be generated by performing weighted summation of prediction signals of the derived first merge reference block 511 and the derived second merge reference block 521.

Herein, the number of merge candidates in the GPM merge candidate list may be set to N. Here, N is an arbitrary positive integer that is equal to or greater than 2. In addition, the reference picture 510 in list L0 may represent a past reference picture of the current picture 500 in decoding order, and the reference picture 510 in list L1 may represent a future reference picture of the current picture 500 in decoding order.

The inter-inter prediction of the geometric partitioning mode of FIG. 5 derives motion information by signaling (transmitting/parsing) a corresponding merge index in the GPM merge candidate list according to each partitioned area. Accordingly, many coding bits may be used. In addition, instead of performing a motion information search process to determine motion information, since motion information that is already determined is derived and used from the GPM merge candidate list, there may be a limitation in the accuracy of the motion information.

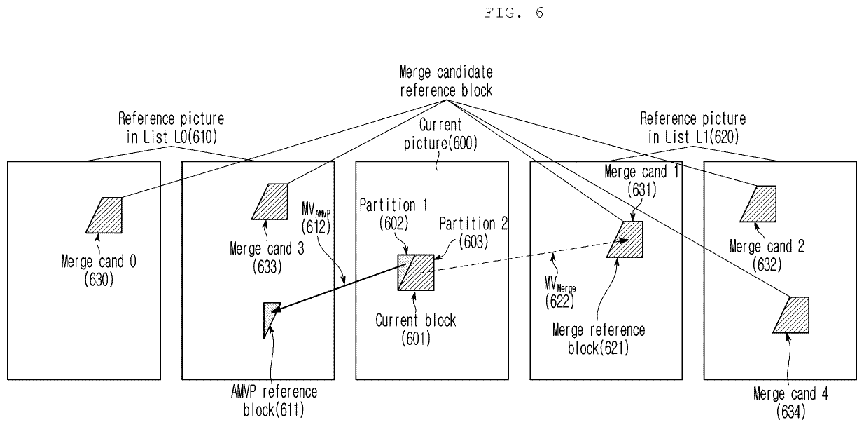

FIG. 6 is a view for describing an AMVP-merge geometric partitioning mode according to an embodiment of the present invention.

In FIG. 6, a reference picture in list L0 610 and a reference picture in list L1 620 represent a past reference picture of a current picture 600 in decoding order and a future reference picture of the current picture 600 in decoding order, respectively. In addition, an AMVP reference block 611 and a merge reference block 621 represent a prediction block of a first partitioned area (Partition 1) 602 that is indicated by a motion vector MVAMVP 612 of the first partitioned area 602 selected by an AMVP mode and a prediction block of a second partitioned area 603 that is indicated by a motion vector MVMerge 622 of a second partitioned area (Partition 2) 603 selected by a merge mode, respectively. In addition, merge candidate 0 (Merge cand 0) 630, merge candidate 1 (Merge cand 1) 631, merge candidate 2 (Merge cand 2) 632, merge candidate 3 (Merge cand 3) 633, and merge candidate 4 (Merge cand 4) 634 represent merge candidate blocks that are indicated by motion vectors of respective merge candidates in a GPM merge candidate list.

In the embodiment of the AMVP-merge geometric partitioning mode of FIG. 6, the first partitioned area 602 is predicted in the AMVP mode and the second partitioned area 603 is predicted in the merge mode, but this is merely one example, and the first partitioned area 602 and the second partitioned area 603 may be predicted by arbitrarily selecting each of the AMVP mode and the merge mode.

Meanwhile, the AMVP-merge geometric partitioning mode is a bi-directional prediction mode, and the reference picture of the AMVP mode and the reference picture of the merge mode should each be reference pictures in opposite directions. That is, when the reference picture of the AMVP mode is a reference picture in direction L0, the reference picture of the merge mode should be a reference picture in direction L1. On the other hand, when the reference picture of the AMVP mode is a reference picture in direction L1, the reference picture of the merge mode should be a reference picture in direction L0.

As another embodiment, in the AMVP-merge geometric partitioning mode, the reference directions of the reference picture of the AMVP mode and the reference picture of the merge mode may not be opposite to each other. That is, the reference picture of the AMVP mode and the reference picture of the merge mode may have a same reference direction or different reference directions from each other.

In the AMVP-merge geometric partitioning mode, a current block may be partitioned into a first partitioned area and a second partitioned area by a straight partitioning boundary, and a motion vector of an AMVP mode (MVAMVP) and a motion vector of a merge mode (MVMerge) may be derived to minimize distortion between a prediction signal (or prediction sample) 41 first partitioned area that is derived from motion information of the AMVP mode and a prediction signal (or prediction sample) of the second partitioned area that is derived from motion information of each merge candidate in a GPM merge candidate list. Herein, the distortion between the two signals may be calculated by performing bilateral matching (BM) or template matching (TM). In addition, a distortion value may be calculated using various distortion measurement methods such as the sum of absolute difference (SAD) or the sum of squared error (SSE).

AMVP mode motion information may include reference picture information (e.g., a reference index) indicating a reference picture, motion vector prediction information (e.g., a motion vector prediction (MVP) index), and motion vector difference information (e.g., a motion vector difference (MVD)). In the AMVP-merge geometric partitioning mode, among AMVP mode motion information, reference picture information and motion vector difference information may be signaled through a bitstream. When a motion vector of an AMVP mode is derived by template matching, among AMVP mode motion information, motion vector prediction information may be derived through template matching, and otherwise, the motion vector prediction information may be signaled through a bitstream.

Merge mode motion information may include a merge index that indicates a merge candidate in a GPM merge candidate list, whose motion information is to be referenced. The merge index may be determined for a merge candidate that minimizes distortion between a prediction signal derived from the AMVP mode and a prediction signal derived from each merge candidate in the GPM merge candidate list. That is, the merge index may not be signaled through a bitstream but may be derived based on the distortion between the two signals.

As described above, coding efficiency may be improved by not signaling but deriving motion vector prediction information or merge index information.

A bilateral matching-based distortion calculation method and a template matching-based distortion calculation method, each for deriving a merge index in the AMVP-merge geometric partitioning mode, will be described below.

When a current block is in the AMVP-merge geometric partitioning mode, an encoder may calculate distortion between a prediction signal derived based on an AMVP mode and a prediction signal derived from each merge candidate in a merge candidate list and may determine AMVP mode motion information and merge mode motion information that minimize the distortion. In addition, the encoder may encode and include the AMVP mode motion information in a bitstream.

When the current block is in the geometric partitioning mode, a decoder may obtain the AMVP mode motion information through parsing and may derive a merge index of the merge mode by performing a same process as bilateral matching of the encoder.

Meanwhile, the merge index may be determined as an index that indicates an optimal merge candidate among merge candidates that have opposite reference direction L 1-X to reference direction LX (X is 0 or 1) in a reference picture list of the AMVP mode. In FIG. 6, since the motion vector MVAMVP 612 of the AMVP mode is motion information in direction L0, the motion vector MVMerge 622 of the merge mode may be selected from merge candidate 1 631, merge candidate 2 632, or merge candidate 4 634, which have motion information in direction L1, among merge candidates in the GPM merge candidate list. Contrary to FIG. 6, when the motion vector MVAMVP of the AMVP mode is motion information in direction L1, the motion vector MVMerge of the merge mode may be selected from merge candidates having motion information in direction L0 among the merge candidates in the GPM merge candidate list. That is, when the motion vector of the AMVP mode is motion information in direction LX (X is 0 or 1), the motion vector of the merge mode may be motion information in direction L 1-X.

Meanwhile, the bilateral matching-based distortion calculation method may not be performed when no merge candidate in a GMP merge candidate list has an opposite reference direction to a reference direction of a reference picture list of an AMVP mode.

As still another embodiment, the bilateral matching-based distortion calculation method may select and determine an optimal merge candidate among all merge candidates in a GPM merge candidate list, irrespective of a reference direction of a reference picture list of an AMVP mode.

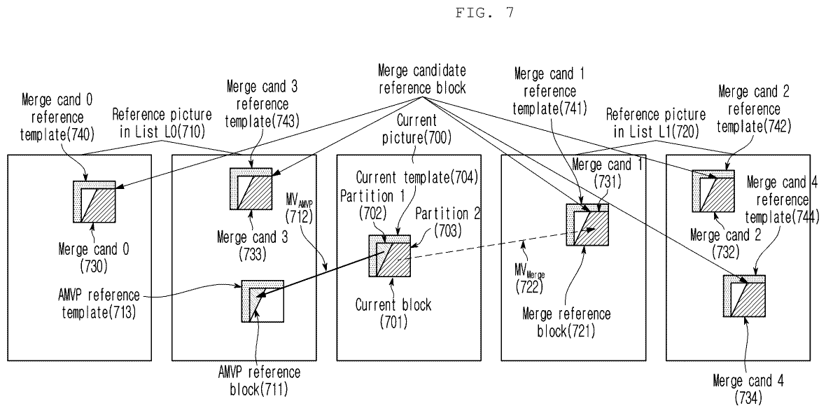

FIG. 7 is a view describing a method for calculating distortion based on template matching to derive a merge index in an AMVP-merge geometric partitioning mode according to an embodiment of the present invention.

In FIG. 7, a reference picture in list L0 710 and a reference picture in list L1 720 represent a past reference picture of a current picture 700 in decoding order and a future reference picture of the current picture 700 in decoding order, respectively. In addition, an AMVP reference block 711 represents a prediction block of a first partitioned area (Partition 1) 702 that is indicated by a motion vector MVAMVP 712 of the first partitioned area 702 selected by an AMVP mode, and a merge reference block 712 represents a prediction block of a second partitioned area (Partition 2) 703 that is indicated by a motion vector MVMerge 722 of the second partitioned area 703 selected by a merge mode. In addition, merge candidate 0 (Merge cand 0) 730, merge candidate 1 (Merge cand 1) 731, merge candidate 2 (Merge cand 2) 732, merge candidate 3 (Merge cand 3) 733, and merge candidate 4 (Merge cand 4) 734 represent merge candidate blocks that are indicated by motion vectors of respective merge candidates in a GPM merge candidate list.

Referring to FIG. 7, when a current block 701 is in the AMVP-merge geometric partitioning mode, an encoder may determine AMVP mode motion information and merge mode motion information that minimize distortion between reference templates of an AMVP-merge mode, which are generated by performing weighted summation of a current template 704 generated from a neighboring reference sample of the current block 701, a neighboring L-shaped reference template (AMVP reference template) 713 of a prediction block (AMVP reference block) 711 derived from an AMVP mode, and neighboring L-shaped reference templates (merge cand M reference templates) 740 to 744 (M∈{0, 1, 2, 3, 4}) of prediction blocks (merge cand M) 730 to 734 (M∈{0, 1, 2, 3, 4}) derived from a merge mode. In addition, the encoder may encode and include the AMVP mode motion information in a bitstream.

When the current block is in the AMVP-merge geometric partitioning mode, a decoder may obtain the AMVP mode motion information through parsing and may derive a merge index of the merge mode by performing a same process as template matching of the encoder.

As another embodiment, when a current block is in the AMVP-merge geometric partitioning mode, a decoder may derive AMVP motion vector prediction information of AMVP mode motion information and a merge index of a merge mode from a GPM merge candidate list by performing a same process as template matching of an encoder. In this case, among AMVP mode motion information, reference picture information and motion vector difference information may be obtained from a bitstream.

Meanwhile, the merge index may be determined as an index that indicates an optimal merge candidate among merge candidates that have opposite reference direction L 1-X to reference direction LX (X is 0 or 1) in a reference picture list of the AMVP mode. In FIG. 7, since the motion vector MVAMVP 712 of the AMVP mode is motion information in direction L0, the motion vector MVMerge 722 of the merge mode may be selected from merge candidate 1 731, merge candidate 2 732, or merge candidate 4 734, which have motion information in direction L1, among merge candidates in the GPM merge candidate list. That is, when the motion vector of the AMVP mode is motion information in direction LX (X is 0 or 1), the motion vector of the merge mode may be motion information in direction L 1-X.

Meanwhile, the template matching-based distortion calculation method may not be performed when no merge candidate in a GMP merge candidate list has an opposite reference direction to a reference direction of a reference picture list of an AMVP mode.

As another embodiment, the template matching-based distortion calculation method may select and determine an optimal merge candidate among all merge candidates in a GPM merge candidate list, irrespective of a reference direction of a reference picture list of an AMVP mode.

Meanwhile, the size and shape of a reference template used in the template matching-based distortion calculation method may be arbitrarily determined. Although an L-shaped template is described in FIG. 7, a template may be constructed using only a left reference sample, or a template may be constructed using only an upper reference sample.

As another embodiment, the shape of a template of a first partitioned area and the shape of a template of a second partitioned area of a geometric partitioning mode may be determined according to a partition angle. Based on the determined shapes of the templates, the template matching-based distortion calculation method may be performed.

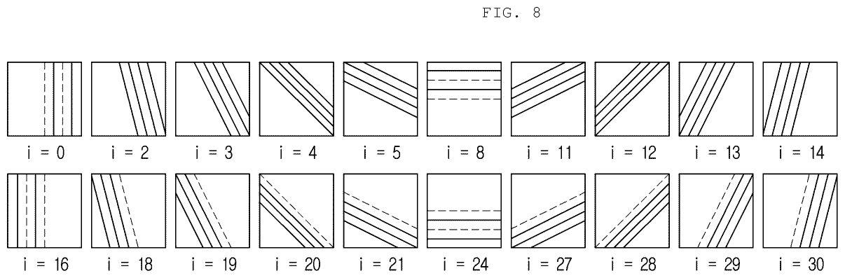

Table 1 shows the template shape of each partitioned area of a geometric partitioning mode according to 20 partition angles. FIG. 8 is a view illustrating the partition angles of Table 1.

TABLE 1

| Partition angle | 0 | 2 | 3 | 4 | 5 | 8 | 11 | 12 | 13 | 14 |
|---|---|---|---|---|---|---|---|---|---|---|
| First | Upper | Upper | Upper | Upper | L- | L- | L- | L- | Upper | Upper |
| partitioned | | | | | shaped | shaped | shaped | shaped | | |
| area | | | | | | | | | | |
| Second | L- | L- | L- | Left | Left | Left | Left | L- | L- | L- |
| partitioned | shaped | shaped | shaped | | | | | shaped | shaped | shaped |
| area | | | | | | | | | | |
| Partition angle | 16 | 18 | 19 | 20 | 21 | 24 | 27 | 28 | 29 | 30 |
| First | Upper | Upper | Upper | Upper | L- | L- | L- | L- | Upper | Upper |
| partitioned | | | | | shaped | shaped | shaped | shaped | | |
| area | | | | | | | | | | |
| Second | L- | L- | L- | Left | Left | Left | Left | L- | L- | L- |
| partitioned | shaped | shaped | shaped | | | | | shaped | shaped | shaped |
| area | | | | | | | | | | |

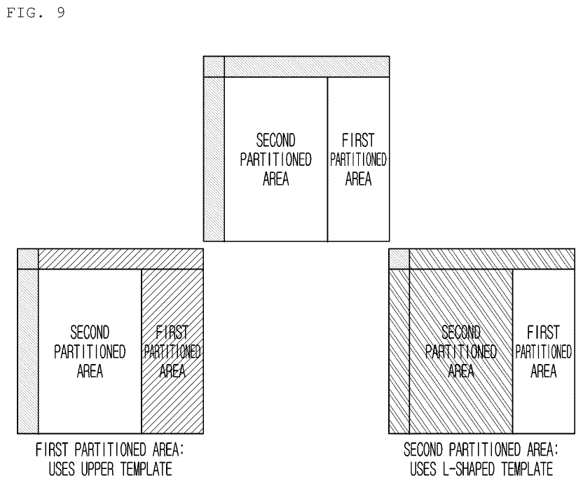

FIG. 9 is a view illustrating a template shape of a first partitioned area and a template shape of a second partitioned area when a partition angle is 0.

Referring to FIG. 9, when the partition angle is 0, the template of a first partitioned area may be an upper template that is formed with an upper neighboring reference sample, and the template of a second partitioned area may be an L-shaped template that is formed with upper and left neighboring reference samples.

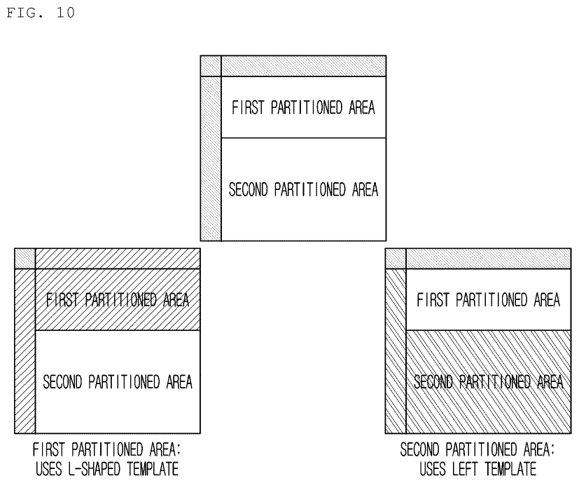

FIG. 10 is a view illustrating a template shape of a first partitioned area and a template shape of a second partitioned area when a partition angle is 8.

Referring to FIG. 10, when the partition angle is 8, the template of a first partitioned area may be an L-shaped template that is formed with upper and left neighboring reference samples, and the template of a second partitioned area may be a left template that is formed with a left neighboring reference sample.

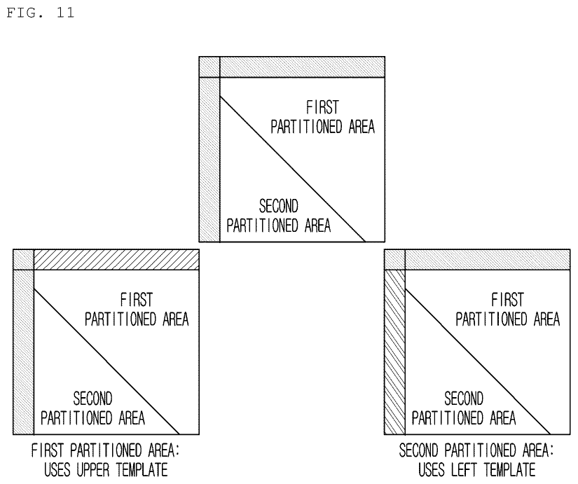

FIG. 11 is a view illustrating a template shape of a first partitioned area and a template shape of a second partitioned area when a partition angle is 20.

Referring to FIG. 11, when the partition angle is 20, the template of a first partitioned area may be an upper template that is formed with an upper neighboring reference sample, and the template of a second partitioned area may be a left template that is formed with a left neighboring reference sample.

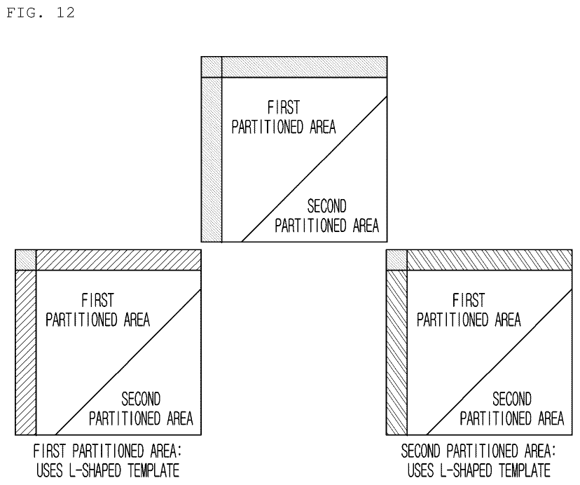

FIG. 12 is a view illustrating a template shape of a first partitioned area and a template shape of a second partitioned area when a partition angle is 28.

Referring to FIG. 12, when the partition angle is 28, both the template of a first partitioned area and the template of a second partitioned area may be an L-shaped template that is formed with upper and left neighboring reference samples.

Meanwhile, Table 1 shows merely one example, and L templates with various sizes and shapes may be used for K partition angles. Herein, K and L are arbitrary positive integers.

In the AMVP-merge geometric partitioning mode, a prediction signal of an AMVP mode and a prediction signal of a merge mode may be derived by using AMVP mode motion information and merge mode motion information, respectively, which are derived through either the lateral matching-based distortion calculation method or the template matching-based distortion calculation method. A final prediction signal of the AMVP-merge geometric partitioning mode may be generated by performing weighted summation of the derived prediction signal of the AMVP mode and the derived prediction signal of the merge mode. Herein, a weight of the weighted summation may be determined based on a partitioning boundary.

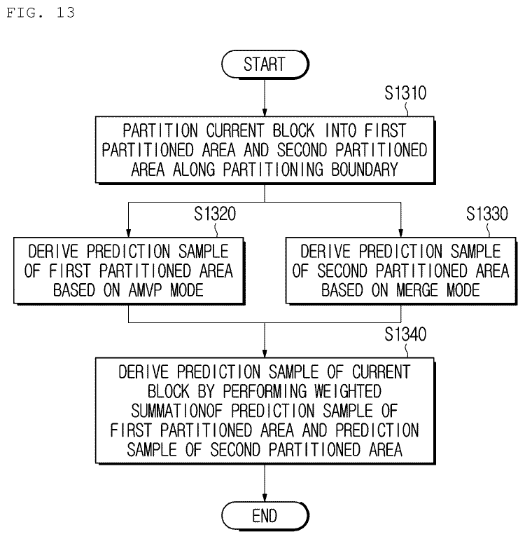

FIG. 13 is a flowchart showing a method for decoding an image according to an embodiment of the present invention. The image decoding method of FIG. 13 may be performed by an image decoding apparatus.

The image decoding apparatus may partition a current block into a first partitioned area and a second partitioned area along a partitioning boundary (S1310).

In addition, the image decoding apparatus may derive a prediction sample of the first partitioned area based on an advanced motion vector prediction (AMVP) mode (S1320). Specifically, the prediction sample of the first partitioned area may be derived based on AMVP motion information that is obtained from a bitstream. Herein, the AMVP motion information may include motion vector difference information and reference picture information.

Meanwhile, among the AMVP motion information, motion vector prediction information may be derived through a template matching method or may be obtained from a bitstream.

In addition, the image decoding apparatus may derive a prediction sample of the second partitioned area based on a merge mode (S1330). Specifically, the prediction sample of the second partitioned area may be derived based on motion information of a merge candidate that is selected from a plurality of merge candidates. Herein, the selected merge candidate may be determined based on distortion of the prediction sample of the first partitioned area and candidate prediction samples of the second partitioned area based on motion information of each of the plurality of merge candidates. The distortion may be calculated based on bilateral matching.

Meanwhile, the distortion may be calculated based on template matching. In this case, the template matching may use an L-shaped template.

In addition, the template matching may use any one template of an upper template and a left template.

In addition, the template matching may use a template that is determined according to the partitioning boundary.

In addition, the image decoding apparatus may derive a prediction sample of the current block by performing weighted summation of the prediction sample of the first partitioned area and the prediction sample of the second partitioned area (S1340).

Meanwhile, the steps described in FIG. 13 may be performed likewise in an image encoding method. In addition, a bitstream may be generated by an image encoding method including the steps described in FIG. 13. The bitstream may be stored in a non-transitory computer-readable recording medium and also be transmitted (or streamed).

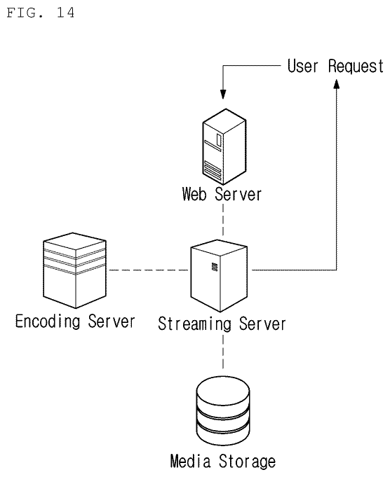

FIG. 14 is a view for illustrating a content streaming system to which an embodiment according to the present invention is applicable.

As illustrated in FIG. 14, the content streaming system, to which an embodiment of the present invention is applied, may largely include an encoding server, a streaming server, a web server, a media storage, a user device, and a multimedia input device.

The encoding server may compress the content input from multimedia input devices such as a smartphone, a camera and CCTV into digital data to generate a bitstream and transmit it to the streaming server. As another example, when the multimedia input devices such as the smartphone, the camera and the CCTV generate a bitstream on their own, the encoding server may be omitted.

The bitstream may be generated by an image encoding method and/or an image encoding apparatus, to which an embodiment of the present invention is applied, and the streaming server may temporarily store the bitstream in the process of transmitting or receiving the bitstream.

The streaming server transmits multimedia data to the user device based on a user request through the web server, and the web server serves as an intermediary to inform the user of what service is present. When a user requests a desired service to the web server, the web server delivers it to the streaming server, and the streaming server may transmit multimedia data to the user. At this time, the content streaming system may include a separate control server, in which case the control server serves to control commands/responses between devices in the content streaming system.

The streaming server may receive contents from the media storage and/or the encoding server. For example, when the streaming server receives contents from the encoding server, the streaming server may the contents in real time. In this case, to provide a smooth streaming service, the streaming server may store the bitstream for a predetermined time.

Examples of the user devices may include mobile phones, smartphones, laptop computers, digital broadcasting terminals, personal digital assistants (PDAs), portable multimedia players (PMPs), navigation devices, slate PCs, tablet PCs, ultrabooks, wearable devices (e.g., smartwatches, smart glasses, HMDs), digital TVs, desktop computers, digital signage, etc.

Each server in the above content streaming system may be operated as a distributed server, in which case data received from each server may be distributed and processed.

The above embodiments may be performed in the same or corresponding manner in the encoding apparatus and the decoding apparatus. In addition, an image may be encoded/decoded using at least one or a combination of at least one of the above embodiments.

The order in which the above embodiments are applied may be different in the encoding apparatus and the decoding apparatus. Alternatively, the order in which the above embodiments are applied may be the same in the encoding apparatus and the decoding apparatus.

The above embodiments may be performed for each of the luma and chroma signals. Alternatively, the above embodiments for the luma and chroma signals may be performed identically.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

The embodiments may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present invention, or well-known to a person of ordinary skilled in the computer software technology field.

A bitstream generated by the encoding method according to the above embodiment may be stored in a non-transitory computer-readable recording medium. In addition, a bitstream stored in the non-transitory computer-readable recording medium may be decoded by the decoding method according to the above embodiment.

Examples of the computer-readable recording medium include magnetic recording media such as hard disks, floppy disks, and magnetic tapes; optical data storage media such as CD-ROMS or DVD-ROMs; magneto-optimum media such as floptical disks; and hardware devices, such as read-only memory (ROM), random-access memory (RAM), flash which are memory, etc., particularly structured to store and implement the program instruction. Examples of the program instructions include not only a mechanical language code formatted by a compiler but also a high-level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### INDUSTRIAL APPLICABILITY

The present invention may be used in an apparatus for encoding/decoding an image and a recording medium for storing a bitstream.

What is claimed is:

1. A method for decoding an image, the method comprising:
partitioning a current block into a first partitioned area and a second partitioned area along a partitioning boundary;
deriving a prediction sample of the first partitioned area based on an advanced motion vector prediction (AMVP) mode;
deriving a prediction sample of the second partitioned area based on a merge mode; and
deriving a prediction sample of the current block by performing weighted summation of the prediction sample of the first partitioned area and the prediction sample of the second partitioned area.

2. The method of claim 1, wherein the prediction sample of the first partitioned area is derived based on AMVP motion information that is obtained from a bitstream.

3. The method of claim 2, wherein the AMVP motion information includes motion vector difference information and reference picture information.

4. The method of claim 1, wherein the prediction sample of the second partitioned area is derived based on motion information of a merge candidate that is selected from a plurality of merge candidates.

5. The method of claim 4, wherein the selected merge candidate is determined based on distortion of the prediction sample of the first partitioned area and candidate prediction samples of the second partitioned area based on motion information of each of the plurality of merge candidates.

6. The method of claim 5, wherein the distortion is calculated based on bilateral matching.

7. The method of claim 5, wherein the distortion is calculated based on template matching.

8. The method of claim 7, wherein the template matching uses an L-shaped template.

9. The method of claim 7, wherein the template matching uses any one template of an upper template and a left template.

10. The method of claim 7, wherein the template matching uses a template that is determined according to the partitioning boundary.

11. The method of claim 1, wherein a reference picture of the AMVP mode and a reference picture of the merge mode are in different directions from each other.

12. A method for encoding an image, the method comprising: partitioning a current block into a first partitioned area and a second partitioned area along a partitioning boundary;
deriving a prediction sample of the first partitioned area based on an advanced motion vector prediction (AMVP) mode;
deriving a prediction sample of the second partitioned area based on a merge mode; and
deriving a prediction sample of the current block by performing weighted summation of the prediction sample of the first partitioned area and the prediction sample of the second partitioned area.

13. (canceled)

14. A method for transmitting a bitstream, the bitstream being generated by a method for encoding an image,
wherein the method for transmitting the bitstream comprises transmitting the bitstream, and
wherein the method for encoding the image comprises:
partitioning a current block into a first partitioned area and a second partitioned area along a partitioning boundary;
deriving a prediction sample of the first partitioned area based on an advanced motion vector prediction (AMVP) mode;
deriving a prediction sample of the second partitioned area based on a merge mode; and
deriving a prediction sample of the current block by performing weighted summation of the prediction sample of the first partitioned area and the prediction sample of the second partitioned area.
